(19) United States
(12) Patent Application Publication
(10) Pub. No.: US 2025/0260589 A1
(43) Pub. Date: Aug. 14, 2025

(54) Multi-Key Cryptography Systems, Methods And Products

(71) Applicant: Timothy Edgin, Houston, TX (US)

(72) Inventor: Timothy Edgin, Houston, TX (US)

(21) Appl. No.: 18/438,430

(22) Filed: Feb. 10, 2024

(51) Int. Cl. H04L 9/00; H04L 9/14

(52) U.S. Cl. CPC H04L 9/50; H04L 9/14

(57) ABSTRACT

Systems, methods and products for multi-key cryptography for blockchains and secure access to resources is provided using two public or private blockchain distributed ledgers wherein one blockchain stores a public key in Smart Contracts/metadata and the other stores a private key and the public key is only accessed by authorized persons with the private key.

### FIELD OF THE INVENTION

The invention relates to the use of public/private key cryptography for blockchain security and access to resources.

### BACKGROUND OF THE INVENTION

The reliable use of blockchain distributed networks to gain access to resources is important to improve the use of such resources and to decrease the likelihood of successful cyber-attacks. This is especially true for resources used by remote workers that gain access to a company's systems, applications, and data, and many other applications. Improved systems and methods are needed for providing more reliable and secure access to resources. One such tool used to attempt to secure blockchains is the use of public/private key cryptography. The public keys are potentially exposed to the general public, making the blockchain susceptible to hacking. Improved systems and methods for using public keys are needed.

### SUMMARY OF THE INVENTION

Certain embodiments of this invention provide systems and methods for poly-key cryptography that are more reliable and secure. Public/private key cryptography is improved and otherwise strengthened by this invention. Preferred embodiments of this invention carry the public key on one public or private blockchain and deliver it to only authorized parties that would need access to the key, while private keys are carried on a separate public or private blockchain created just for delivering the private keys. This functionality ensures that the public key is never exposed to the general public, and instead is only provided to authorized persons on the blockchain. Thus, to hack the systems and methods of this invention, a hacker would need to compromise the blockchain and then hack the public key to compromise the system, making such a hack exponentially more difficult.

Preferred embodiments of this invention include systems for securing a resource using public or private blockchain distributed networks for authorized parties. The systems comprise (a) a public key that is provided on a first public or private blockchain that is delivered to the authorized parties that require access to the public key and which is not exposed to the general public; (b) a private key that is provided on a second public or private blockchain that is created to deliver the private key; and (c) wherein both the public key and the private key are required to obtain access to the resource.

Preferred embodiments of this invention also include methods for securing access to a resource and using public or private blockchain distributed networks for authorized parties. Certain embodiments of these methods comprise (a) providing a public key on a first public or private blockchain; (b) delivering the public key to the authorized parties that require access to the public key and not exposing it to the general public; (c) using a second public or private blockchain; (d) providing a private key on the second public or private blockchain; and (e) wherein both the public key and the private key are needed to have access to the resource.

Preferred embodiments of this invention also include computer program products for securing resources and blockchain distributed networks for authorized parties. The computer program products comprise computer readable instructions, which provide the capability to (a) provide a public key on a first public or private blockchain; (b) deliver the public key to the authorized parties that require access to the public key and not exposing it to the general public; (c) use a second public or private blockchain; (d) providing a private key on the second public or private blockchain; and (e) wherein both the public key and the private key are needed to have access to the resource.

The public and private keys may be in any suitable format, including those based on RSA or elliptic curve cryptography (ECC).

Applications for the embodiments of this invention include improving the security of blockchain distributed networks and resources (e.g., computer applications, company internal systems, financial transactions, bank accounts). The person of skill in the art understands how this application and combining of this invention can be done with additional applications requiring authentication, verification, identification and avoidance of cyber-attacks. Applications of this invention include but are not limited to financial transactions, supply chain records, healthcare, medical records, cybersecurity, and personal identity, among others.

Advantages of the embodiments of this invention are described and apparent throughout this specification. For example, certain embodiments will enhance a resource's security by making the systems more difficult to hack. Certain embodiments of this invention solve this problem and they are not vulnerable, or as vulnerable, to such attacks.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a schematic that illustrates a flowchart concerning a request for access to a resource of embodiments of this invention.

### DETAILED DESCRIPTION OF THE INVENTION

Improved cryptography is central to improving and maintaining cybersecurity. Cybercriminals constantly evolve to work around cryptography tools and other security systems. One such cryptography tool is Public Key Cryptography or Asymmetric Encryption. It is the basis for providing public keys and private keys to secure access to resources and blockchain distributed networks, including, for example, the wallets used in such.

For purposes of illustration, regarding blockchain wallets, the goal of the public keys and private keys is to ensure that a spent transaction was signed by the owner of the funds and was not forged. In this example, a person that owns a cryptocurrency really owns a private key that unlocks the right for its owner to spend the associated cryptocurrencies. Because it provides access to the cryptocurrencies, it should remain strictly private.

It is possible that the private key can be used to recover the public key. However, it is virtually impossible to find the private key using only the public key. Using this example further, the public key is responsible for the address to a blockchain wallet and thus it can be shared with anyone who needs it. Conversely, a private key is the code that allows anyone to access to what is stored at that public address and it should not be shared with just anyone. Specifically, public keys function like an address or an account number and are generally visible to all users in the network, and sometimes outside of the network. Public keys are actually used to create blockchain addresses, that are shared with other people.

The two main uses for public keys and private keys are encryption and signing. Encryption with a public key makes sure the intended recipient can read information while signing with a private key is for verifying the authenticity of a transaction and confirming it was not forged or tampered with. However, in the context of standard blockchain distributed networks, encryption with the public key is not used, as the most important function is signing.

Preferred embodiments of this invention are directed to securing a resource for authorized parties using public or private blockchain distributed networks. The systems, methods and products of this invention comprise a public key that is provided on a public or private blockchain that is delivered to only authorized parties that require access to the public key. Thus, the invention uses a public key that is not available to the public at large, but, instead it is restricted to authorized parties that specifically need and request access to the public key. Without access to even the public key, the systems, methods and products of this invention are even harder to hack.

Preferred embodiments of this invention also comprise a private key. This private key is provided on a second, different public or private blockchain than the blockchain that holds the public key.

The subject matter of this disclosure is now described with reference to the following examples. These examples are provided for the purpose of illustration only, and the subject matter is not limited to these examples, but rather encompasses all variations which are evident as a result of the teaching provided herein.

### Example 1

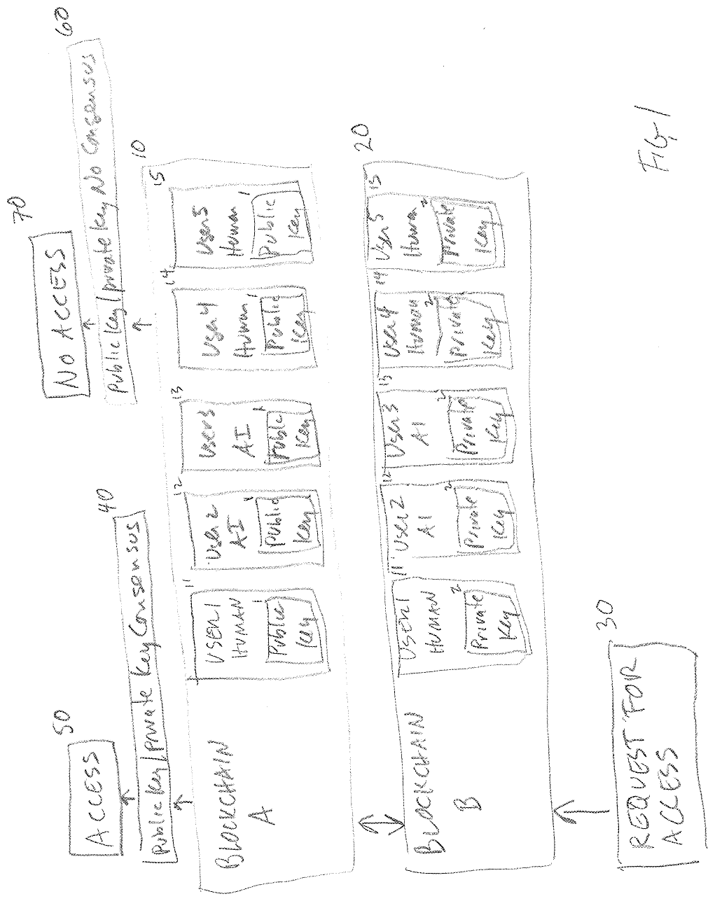

In this embodiment of the invention, shown in FIG. 1, the Public Key 1 is hidden in Smart Contracts/metadata on a blockchain distributed ledger network (with five users, three human 11, 14, 15, and two artificial intelligence or AI 12, 13) in a private key infrastructure that comprises the following:

A Blockchain A 10 is used and it is a private or public blockchain that delivers public keys 1 via channel A. The Key Pairs have an expiration encoded.

A Blockchain B 20 is also used. A token or invitation request for access 30 is sent to the users' secure Agent (wallet) on Blockchain B 20. The user's Agent then takes the private key 2 and passes it to Blockchain A10, which checks to see if a matching public key 1 is at the address specified with the private key 2. If there is such a matching 40 public key 1, the transaction proceeds forward 50.

### Particular Applications to Computer Devices

The system applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A system for securing access to a resource using public or private blockchain distributed networks for authorized parties, the system comprising:
a. a public key that is provided on a first public or private blockchain that is delivered to the authorized parties that require access to the public key and which is not exposed to the general public;
b. a private key that is provided on a second public or private blockchain that is created to deliver the private key to the first blockchain; and
c. wherein both the public key and the private key are required to gain access to the resource.

2. A method for securing access to a resource using public or private blockchain distributed networks for authorized parties, the method comprising:
a. providing a public key on a first public or private blockchain;
b. providing a private key on a second public or private blockchain; and
c. delivering the public key in response to a request to the second blockchain to the authorized parties that require access to the public key and not exposing the public key to the general public;
d. granting access to the resource when the public key and the private key are correct.

3. A computer program product for securing access to a resource to authorized parties using blockchain distributed networks, the computer program product comprising computer readable instructions, the instructions comprising the capability to:
a. provide a public key on a first public or private blockchain;
b. provide a private key on a second public or private blockchain;
c. deliver the public key to the authorized parties that require access to the public key and not exposing it to the general public when a request for access to the resource is made; and
d. wherein the correct public key and private key are needed to grant access to the resource to the authorized parties.
